(19) United States
(12) Patent Application Publication
(10) Pub. No.: US 2026/0057857 A1
(43) Pub. Date: Feb. 26, 2026

(54) HI-HAT BRASS CYMBAL STAND

(71) Applicant: K.H.S. MUSICAL INSTRUMENT CO., LTD., New Taipei City (TW)

(72) Inventor: Chan-Hsu LIN, New Taipei City (TW)

(73) Assignee: K.H.S. MUSICAL INSTRUMENT CO., LTD., New Taipei City (TW)

(21) Appl. No.: 18/814,344

(22) Filed: Aug. 23, 2024

(51) Int. Cl. G10D 13/065

(52) U.S. Cl. CPC G10D 13/065

(57) ABSTRACT

A Hi-hat brass cymbal stand is disclosed, which includes: a storage seat, a foot stand, a fixer, a first tube body, an assembling and disassembling member, a second tube body, and a pedal mechanism. The storage seat has a base plate and a storage tube mounted on the base plate. The second tube body is connected above the first tube body, and has a second joint tube, a second pulling mechanism located inside the second joint tube, a clutch and a brass cymbal seat. The brass cymbal seat is mounted on the top of the second joint tube, and the second pulling mechanism will pass through the brass cymbal seat and then connected to the clutch, wherein the second tube body can be disassembled and inserted into the storage tube for storage, and the second pulling mechanism can be fixed to the base plate. When the second joint tube moves, the brass cymbal seat will abut against the clutch, so that the second joint tube cannot be separated from the storage tube. In this way, the Hi-hat brass cymbal stand can be shortened in height for a user to storage and carry, and parts of the Hi-hat brass cymbal stand can be prevented from falling off.

### FIELD OF THE INVENTION

The present invention relates to a Hi-hat brass cymbal stand, and in particular to a Hi-hat brass cymbal stand which allows a user to shorten a height of the Hi-hat brass cymbal stand in a longitudinal direction after the Hi-hat brass cymbal stand is stored.

### BACKGROUND OF THE INVENTION

A Hi-hat brass cymbal stand is a stand for percussion instruments. It is mainly used for supporting and fixing upper brass cymbals and lower brass cymbals. A user can control the opening and closing of the brass cymbal by stepping on pedals to create a variety of rhythms and timbres. It has the advantages of having a simple design, being easy to install and disassemble, and being adjustable, which can meet the demands of different users.

However, when the Hi-hat brass cymbal stand is stored, in order to reduce its volume, the parts need to be disassembled for storage. However, these small and fine parts are often lost without attention during transportation and storage. In order to solve this problem, a product that can reduce the volume of the Hi-hat brass cymbal stand without disassembling the parts has appeared on the market. The foot stand of this product has a retracting function to reduce the width, and the pedals can be folded and retracted to further reduce the volume. However, although this storage manner reduces the lateral width of the Hi-hat brass cymbal stand, it still needs to use a traditional disassembly method for storage in terms of a longitudinal height.

### SUMMARY OF THE INVENTION

A main objective of the present invention is to allow a user to shorten a height of the Hi-hat brass cymbal stand without a part disassembling, so that the user can store and carry it conveniently.

A secondary objective of the present invention is to enable a foot pedal to have a fixing mechanism when stored, so that the foot pedal cannot move relative to the Hi-hat brass cymbal stand.

Another objective of the present invention is to allow the Hi-hat brass cymbal stand to have a buffer that can reduce the sound generated when components collide with each other.

To achieve the foregoing objectives, the Hi-hat brass cymbal stand of the present invention includes: a storage seat, a foot stand, a fixer, a first tube body, an assembling and disassembling member, a second tube body, and a pedal mechanism. The storage seat has a base plate and a storage tube mounted on the base plate. The fixer has a first sleeve hole and a second sleeve hole adjacent to the first sleeve hole, and the storage tube is mounted in the first sleeve hole. The first tube body has a first joint tube and a first pulling mechanism located inside the first joint tube, a lower end of the first joint tube is mounted in the second sleeve hole, and the first pulling mechanism pass through the second sleeve hole to project from the first joint tube. The assembling and disassembling member is connected to an upper end of the first joint tube. The second tube body has a second joint tube, a second pulling mechanism located inside the second joint tube, and a brass cymbal seat. The second joint tube is mounted in the assembling and disassembling member, and the second pulling mechanism is detachably connected to the first pulling mechanism. The brass cymbal seat is mounted on the top of the second joint tube, and the second pulling mechanism pass through the second joint tube to project from the brass cymbal seat. The pedal mechanism is connected between the first pulling mechanism and the base plate, and is provided with a foot pedal, a first connector and a second connector, the first connector is connected between the first pulling mechanism and the foot pedal, and the second connector is connected between the foot pedal and the base plate.

The second joint tube and the second pulling mechanism can be separated from the assembling and disassembling member and the first pulling mechanism respectively, so that the second tube body is inserted into the storage tube to form a storage state, allowing the Hi-hat brass cymbal stand to be shortened from a use height to a storage height.

In this embodiment, the base plate forms a closed end below the storage tube, so that the second tube body enters the storage tube without passing through the base plate. The closed end has a locking hole. The second pulling mechanism is capable of being connected to the locking hole without separating from the storage tube. A clutch is connected to the top end of the second pulling mechanism. The second pulling mechanism is connected to the locking hole after the second tube body enters the storage tube, so that the brass cymbal seat is abutted against the clutch when the second joint tube moves upward, and thus the second joint tube is blocked by the clutch without separating from the storage tube.

Moreover, the foot pedal has a heel area and a sole area connected between the heel area and the first connector, the sole area is pivoted with the first connector and the heel area respectively, and the second connector is connected to the heel area. When the sole area is swung along a first direction relative to the first connector, the heel area also is swung along the first direction, so that the foot pedal, the second connector and the storage tube are arranged longitudinally to form the storage state.

The base plate has two protrusions each forming a socket and a recess formed between the two protrusions, the second connector is configured as a connecting rod pivotally connected between the heel area and the base plate, the connecting rod has two inserting portions inserted into the sockets and a U-shaped portion connected between the two inserting portions and the heel area, the U-shaped portion is capable of being pressed inward by a user to allow the two inserting portions to leave the sockets, so that the connecting rod will be separated from the recess of the base plate.

Furthermore, the recess of the base plate is recessed toward the storage tube to form two grooves, when the two inserting portions leave the sockets, the foot pedal is swung along the first direction, and then the U-shaped portion is moved toward the two grooves to form the storage state, so that two symmetrical sections on two opposite sides of the U-shaped portion enter the two grooves for positioning.

Further, the Hi-hat brass cymbal stand further has a foot stand including a fixed ring connected to the storage tube, a movable ring movably sleeved on the storage tube, and a plurality of foot plates pivotally connected between the fixed ring and the movable ring, when the movable ring is moved close to the fixed ring, the foot plates are swung to form a use state, and when the movable ring is moved far away from the fixed ring, the foot plates are swung relative to the fixed ring to be changed from the use state to the storage state.

Further, the first pulling mechanism includes a buffer located between the first connector and the fixer, and the buffer has a buffer spring and at least one buffer pad, when a user steps on the pedal mechanism, the first pulling mechanism is pulled downward to separate the buffer from the fixer, and when the foot of the user leaves the pedal mechanism, the first pulling mechanism is pushed by the buffer spring to return to an unpulled position.

Finally, the first pulling mechanism has a return spring and a stretching member for being moved, the return spring is connected to the stretching member, and the first joint tube has a spring adjustment ring connected to the stretching member, so that a user is capable of adjusting the tightness of the pedal through the spring adjustment ring when stepping on the pedal.

The present invention is characterized in that the second joint tube and the second pulling mechanism can be separated from the assembling and disassembling member and the first pulling mechanism respectively, and the disassembled second joint tube and the second pulling mechanism can be inserted into the storage tube for storage, so that the height of the Hi-hat brass cymbal stand is shortened and no scattered parts that need to be stored separately are generated in the whole process, which is convenient for a user to store and carry.

### BRIEF DESCRIPTION OF THE DRAWINGS

FIG. 1 is a perspective view of a Hi-hat brass cymbal stand of the present invention;

FIG. 2 is an exploded view of FIG. 1;

FIG. 3A is a cross-sectional view of the Hi-hat brass cymbal stand of the present invention in a use state;

FIG. 3B is a cross-sectional view of the Hi-hat brass cymbal stand of the present invention in a storage state;

FIG. 4 is an enlarged view of a buffer of the present invention;

FIG. 5A is a schematic diagram of a first storage mechanism of the present invention in a use state;

FIG. 5B is a schematic diagram of the first storage mechanism of the present invention in a storage state;

FIG. 6A is a schematic diagram of a second storage mechanism of the present invention in a use state;

FIG. 6B is a schematic diagram of the second storage mechanism of the present invention in a storage state;

FIG. 7A is a schematic diagram of a third storage mechanism of the present invention in a use state; and

FIG. 7B is a schematic diagram of the third storage mechanism of the present invention in a storage state.

### DETAILED DESCRIPTION OF THE PREFERRED EMBODIMENTS

In order to facilitate a deeper and more detailed recognition and understanding of the construction, use and features of the present invention, preferred embodiments are provided and described in detail with reference to the accompanying drawings as follows:

In the accompanying drawings of the present invention, directional terms such as “front”, “back”, “left”, “right”, “up”, and “down” refer to the direction a user faces when stepping on the brass cymbal.

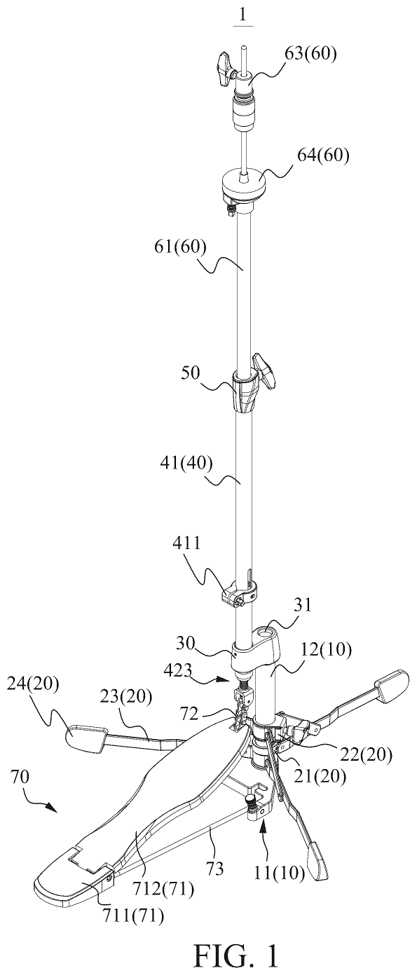

Referring to FIGS. 1, 2, 3A and 3B, a Hi-hat brass cymbal stand 1 of the present invention includes a storage seat 10, a foot pedal 20, a fixer 30, a first tube body 40, a assembling and disassembling member 50, a second tube body 60 and a pedal mechanism 70. The storage seat 10 has a base plate 11 and a storage tube 12 mounted on the base plate 11. In the present embodiment, the foot pedal 20 is connected to the storage tube 12, and has a fixed ring 21 connected to the storage tube 12, a movable ring 22 sleeved on the storage tube 12, a plurality of foot plates 23 pivotally connected between the fixed ring 21 and the movable ring 22, and a plurality of foot pads 24 connected on the plurality of foot plates 23, wherein the base plate 11 is disposed between two of the plurality of foot plates 23.

The fixer 30 has a first sleeve hole 31 and a second sleeve hole 32 adjacent to each other. One end of the storage tube 12 is mounted on the base plate 11, and the other end is mounted on the first sleeve hole 31. The first tube body 40 has a first joint tube 41 and a first pulling mechanism 42 located inside the first joint tube 41. The lower end of the first joint tube 41 is mounted on the second sleeve hole 32 located behind the first sleeve hole 31, and the first pulling mechanism 42 will protrude from the first joint tube 41 through the second sleeve hole 32. The assembling and disassembling member 50 is connected to an upper end of the first joint tube 41. The second tube body 60 has a second joint tube 61, a second pulling mechanism 62 located inside the second joint tube 61, a clutch 63, and a brass cymbal seat 64. The brass cymbal seat 64 has a wool pad, a metal gasket and a brass cymbal pedestal sequentially from top to bottom, wherein the clutch 63 can be connected to an upper brass cymbal and the brass cymbal seat 64 is connected to a lower brass cymbal. The second joint tube 61 can be inserted into the first joint tube 41, and is fixed to an upper end of the first joint tube 41 through the assembling and disassembling member 50. The second pulling mechanism 62 is detachably connected to the first pulling mechanism 42, the clutch 63 is mounted on the top of the second pulling mechanism 62, the brass cymbal seat 64 is mounted on the top of the second joint tube 61, and the second pulling mechanism will protrude the second joint tube to pass through the brass cymbal seat.

The pedal mechanism 70 is connected between the first pulling mechanism 42 and the base plate 11, and has a foot pedal 71, a first connector 72 and a second connector 73. The foot pedal 71 includes a heel area 711 attached to the ground and a sole area 712 pivotally connected to the heel area 711. The first connector 72 is connected between the first pulling mechanism 42 and the sole area 712, and the second connector 73 is pivotally connected between the bottom of the heel area 711 and the base plate 11. When the user steps on the pedal mechanism 70, the first connector 72, the first pulling mechanism 42 and the second pulling mechanism 62 will be pulled downward. At this time, the clutch 63 will approach the brass cymbal seat 64 so that the upper brass cymbal hits the lower brass cymbal, and thereby the user can strike out richer rhythms and timbres.

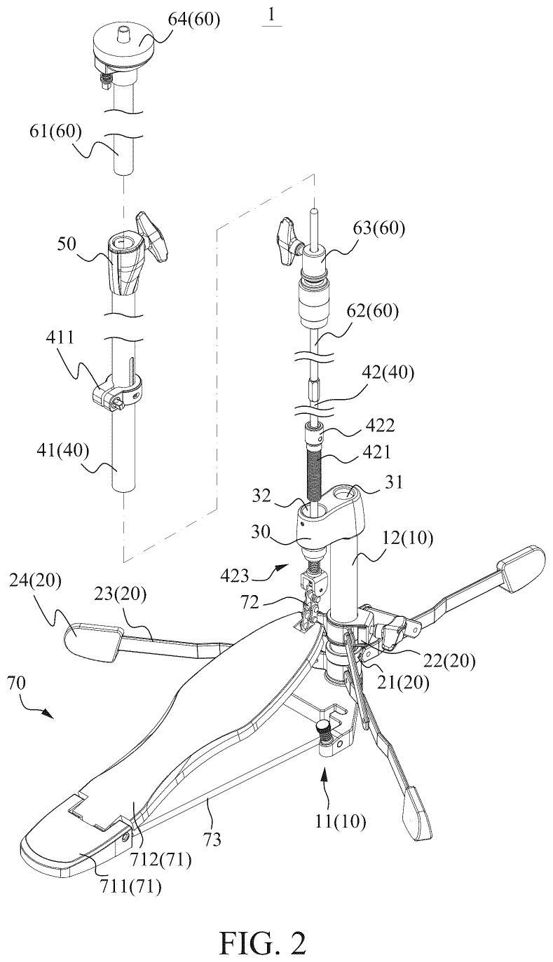

Referring to FIG. 2 again, the first pulling mechanism 42 has a return spring 421 and a movable stretching member 422. The return spring 421 is connected to the stretching member 422. The first joint tube 41 has a spring adjustment ring 411 connected to the stretching member 422. The spring adjustment ring 411 can fix the stretching member 422 so that the user can adjust the tightness of the foot pedal 71 when stepping on it through the return spring 421.

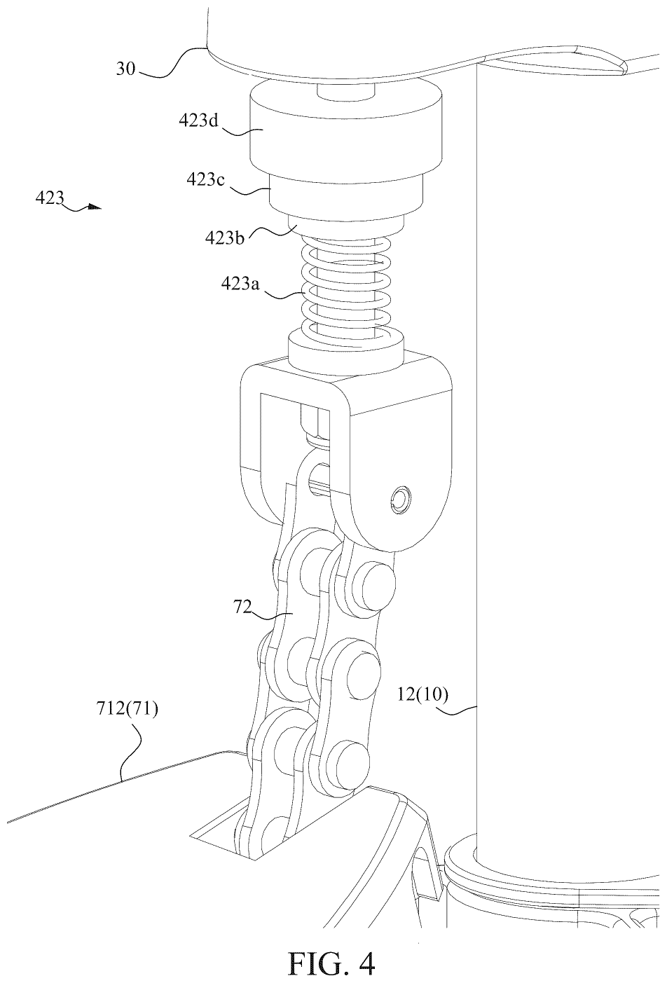

Referring to FIGS. 1, 2 and 4 again, the first pulling mechanism 42 includes a buffer 423. The buffer 423 is located between the first connector 72 and the second sleeve hole 32 of the fixer 30. The buffer has a buffer spring 423a and at least one buffer pad. In this embodiment, the buffer pad has a plastic gasket 423b, a rubber gasket 423c and a felt 423d sequentially from bottom to top. When the user steps on the pedal mechanism 70, the first pulling mechanism 42 is pulled downward, so that the buffer 423 is separated from the fixer 30. When the user separates the pedal mechanism 70, the return spring 421 can restore the first pulling mechanism 42 to an original position. At this time, the buffer 423 can provide a buffering force to the first pulling mechanism 42, and absorb the remaining restoring force through the buffer pad, so that when the buffer 423 returns to the original position, it will not make a loud noise due to hitting the fixer 30.

Moreover, the Hi-hat brass cymbal stand 1 of the present invention includes a first storage mechanism A1, a second storage mechanism A2 and a third storage mechanism A3, which can be adjusted by the user into a use state during performance and a storage state that is convenient for the user to store.

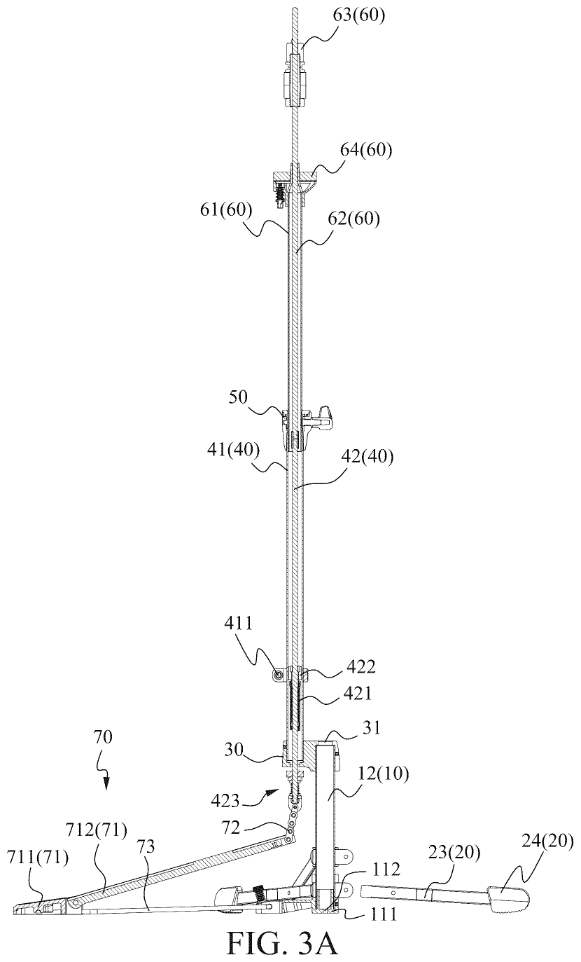

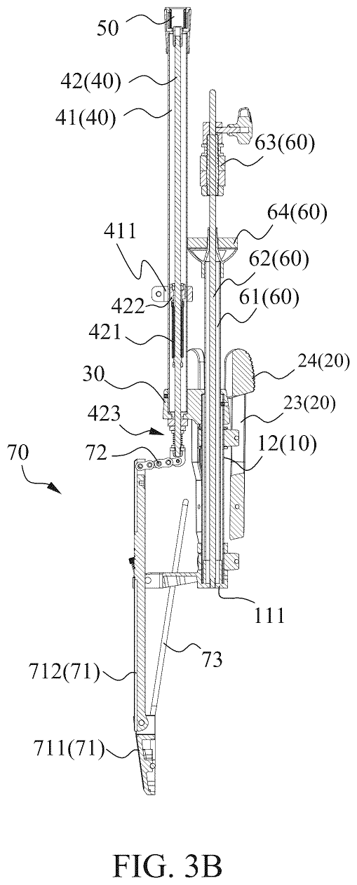

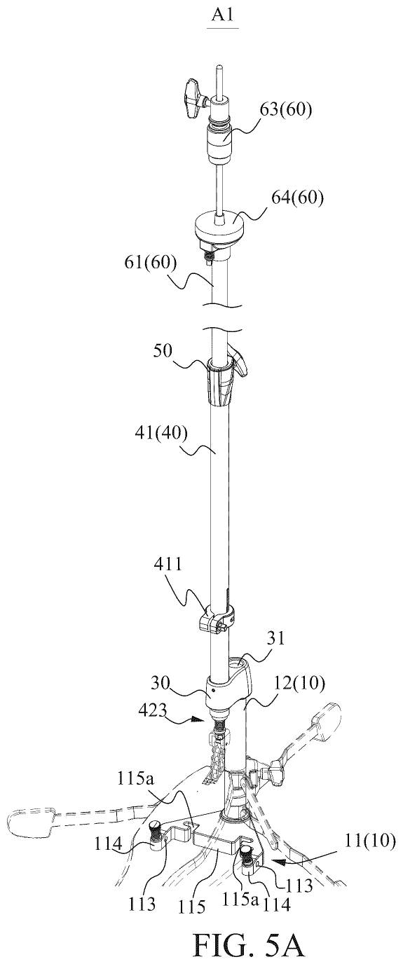

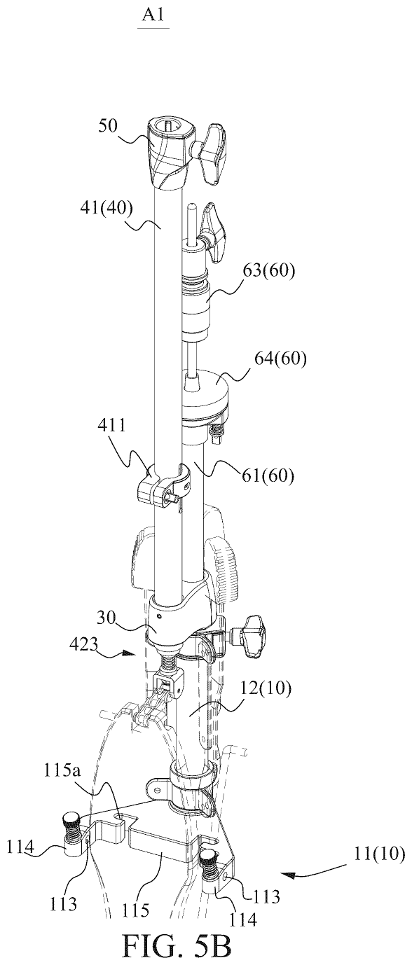

Referring to FIGS. 3A, 3B, 5A and 5B again, the first storage mechanism A1 includes the second tube body 60 and the storage seat 10. The second joint tube 61 and the second pulling mechanism 62 can be separated from the assembling and disassembling member 50 and the first pulling mechanism 42, respectively, so that the second tube body 60 is inserted into the storage tube 12 to form the storage state, and thus the Hi-hat brass cymbal stand 1 is shortened from a use height to a storage height. In this embodiment, the base plate 11 forms a closed end 111 below the storage tube 12, so that the second tube body 60 cannot pass through the base plate 11 after entering the storage tube 12. The closed end 111 has a locking hole 112. The locking hole 112 can be observed from top to bottom through the storage tube 12. When the second tube body 60 enters the storage tube 12, the second pulling mechanism 62 can be connected to the locking hole 112, so that the second pulling mechanism 62 cannot be separated from the storage tube 12. When the second joint tube 61 moves upward, the clutch 63 will be abutted against the brass cymbal seat 64, so that the second joint tube 61 also cannot be separated from the storage tube 12.

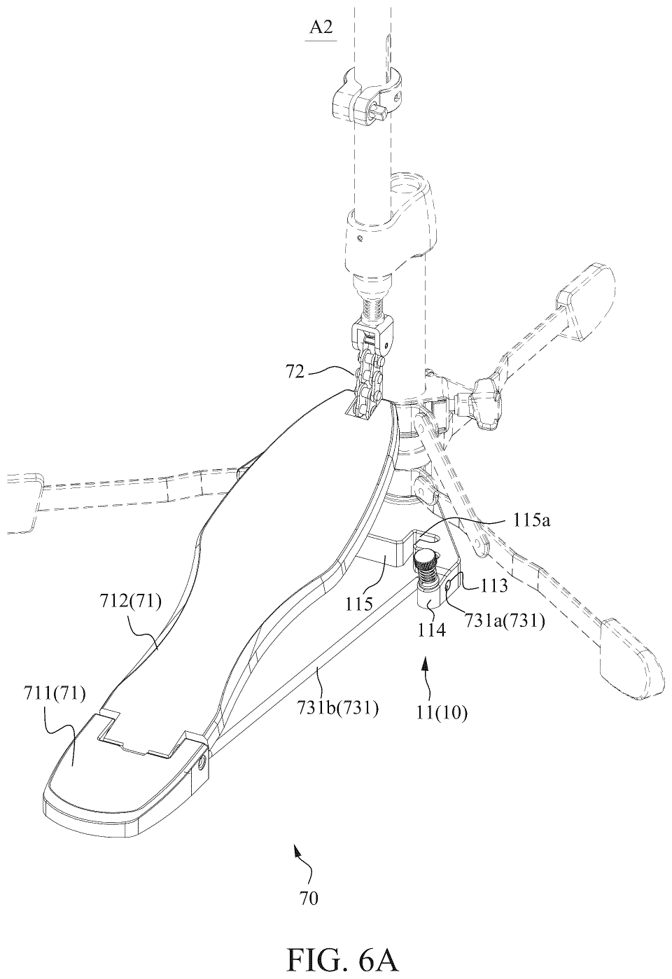

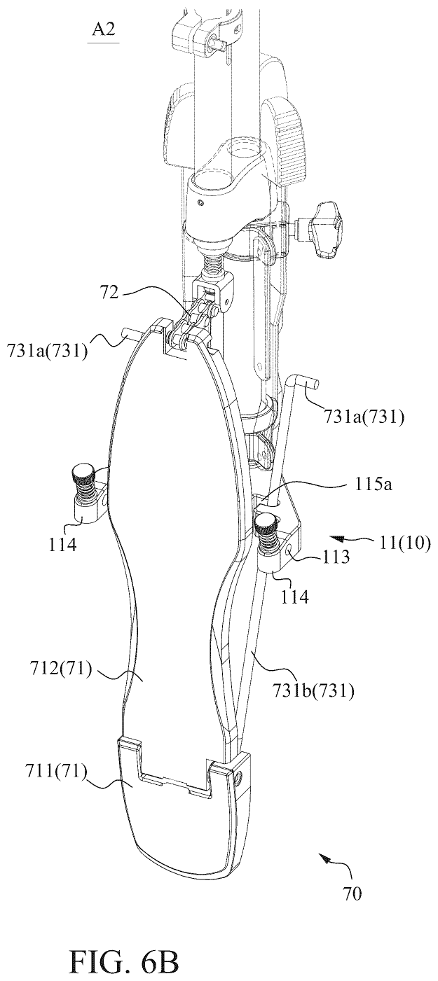

Referring to FIGS. 6A and 6B, the second storage mechanism A2 includes the pedal mechanism 70 and the storage seat 10. The base plate 11 has two protrusions 114 each forming a socket 113 and a recess 115 formed between the two protrusions 114, and the recess 115 is recessed toward the storage tube 12 to form two grooves 115a. The second connector 73 is configured as a connecting rod 731 pivotally connected to the base plate 11, and the connecting rod 731 has two inserting portions 731a inserted into the sockets 113 and a U-shaped portion 731b connected between the two inserting portions 731a and the heel area 711. In this embodiment, the first connector 72 is an iron chain, so that the sole area 712 can be swung relative to the first connector 72 and the heel area 711, respectively, wherein the U-shaped portion 731b can be pressed inward by the user to allow the two inserting portions 731a to leave the sockets 113, then the sole area 712 can be swung along a first direction, and the heel area 711 will also be swung along the first direction, so that the foot pedal 71, the second connector 73 and the storage tube 12 are arranged longitudinally in sequence to form the storage state, and then the U-shaped portion 731b will be moved toward the two grooves 115a, to allow two symmetrical sections on two opposite sides of the U-shaped portion 731b to enter the two grooves 115a for positioning.

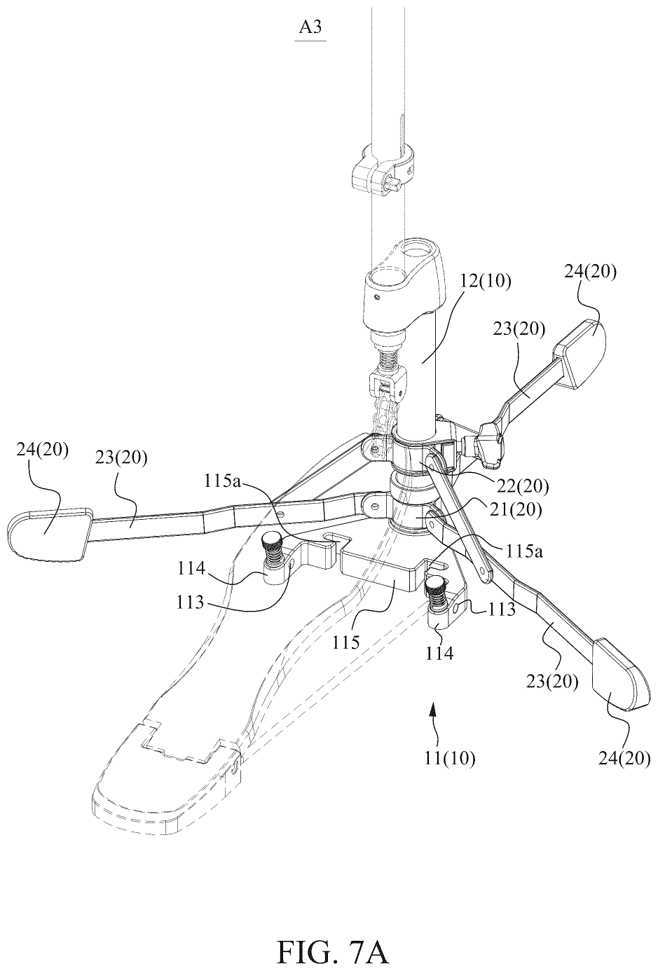

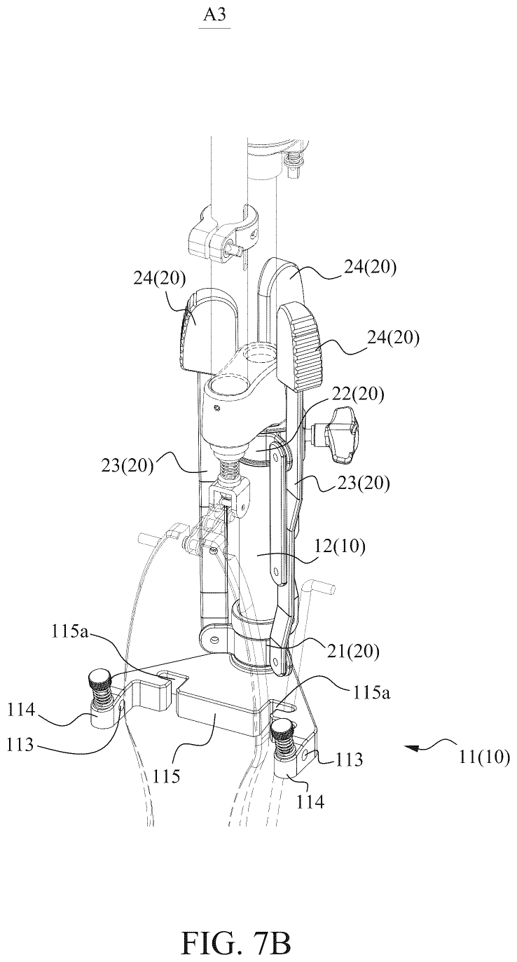

Referring to FIGS. 7A and 7B, the third storage mechanism A3 includes the foot stand 20 and the storage seat 10. When the movable ring 22 is moved close to the fixed ring 21, the plurality of foot plates 23 will swing so that the plurality of foot pads 24 contact the ground and support the Hi-hat brass cymbal stand 1 to stand upright, forming the use state. When the movable ring 22 is moved away from the fixed ring 21, the plurality of foot plates 23 will swing relative to the fixed ring 21 and be changed from the use state to the storage state. At this time, the plurality of foot plates 23 will be adjacent to the storage tube 12.

In summary, the Hi-hat brass cymbal stand 1 of the present invention has the first storage mechanism A1, the second storage mechanism A2 and the third storage mechanism A3 as three locations for storage, and the storage height under the storage state is shorter than that under the use state. Thereby the space occupied by the Hi-hat brass cymbal stand 1 can be reduced without any part disassembling, so that the user can store the Hi-hat brass cymbal stand 1 more conveniently.

What is claimed is:

1. A Hi-hat brass cymbal stand, comprising:
a storage seat having a base plate and a storage tube mounted on the base plate;
a fixer having a first sleeve hole and a second sleeve hole adjacent to the first sleeve hole, and the storage tube is mounted in the first sleeve hole;
a first tube body having a first joint tube and a first pulling mechanism located inside the first joint tube;
a lower end of the first joint tube is mounted in the second sleeve hole, and the first pulling mechanism pass through the second sleeve hole to project from the first joint tube;
an assembling and disassembling member is connected to an upper end of the first joint tube;
a second tube body having a second joint tube, a second pulling mechanism located inside the second joint tube, and a brass cymbal seat, the second joint tube is mounted in the assembling and disassembling member, the second pulling mechanism is detachably connected to the first pulling mechanism, the brass cymbal seat is mounted on a top of the second joint tube, and the second pulling mechanism pass through the second joint tube to project from the brass cymbal seat; and
a pedal mechanism being connected between the first pulling mechanism and the base plate, the pedal mechanism having a foot pedal, a first connector and a second connector, the first connector is connected between the first pulling mechanism and the foot pedal, and the second connector is connected between the foot pedal and the base plate;
wherein the second joint tube and the second pulling mechanism can be separated from the assembling and disassembling member and the first pulling mechanism respectively, so that the second tube body is inserted into the storage tube to form a storage state, allowing the Hi-hat brass cymbal stand to be shortened from a use height to a storage height.

2. The Hi-hat brass cymbal stand according to claim 1, wherein the base plate forms a closed end below the storage tube, so that the second tube body enters the storage tube without passing through the base plate.

3. The Hi-hat brass cymbal stand according to claim 2, wherein the closed end has a locking hole, and when the second tube body enters the storage tube, the second pulling mechanism is capable of being connected to the locking hole without separating from the storage tube.

4. The Hi-hat brass cymbal stand according to claim 3, wherein a top end of the second pulling mechanism is connected with a clutch, and the second pulling mechanism is connected in the locking hole after the second tube body enters the storage tube, so that the brass cymbal seat is abutted against the clutch when the second joint tube moves upward, and thus the second joint tube is blocked by the clutch without separating from the storage tube.

5. The Hi-hat brass cymbal stand according to claim 1, wherein the foot pedal has a heel area and a sole area connected between the heel area and the first connector, the sole area is pivoted with the first connector and the heel area respectively, and the second connector is connected to the heel area, when the sole area is swung along a first direction relative to the first connector, the heel area is also swung along the first direction, so that the foot pedal, the second connector and the storage tube are arranged longitudinally to form the storage state.

6. The Hi-hat brass cymbal stand according to claim 5, wherein the base plate has two protrusions each forming a socket and a recess formed between the two protrusions, the second connector is configured as a connecting rod pivotally connected between the heel area and the base plate, the connecting rod has two inserting portions inserted into the sockets and a U-shaped portion connected between the two inserting portions and the heel area, the U-shaped portion is capable of being pressed inward by a user to allow the two inserting portions to leave the sockets, so that the connecting rod will be separated from the recess of the base plate.

7. The Hi-hat brass cymbal stand according to claim 6, wherein the recess of the base plate is recessed toward the storage tube to form two grooves, when the two inserting portions leave the sockets, the foot pedal is swung along the first direction; and then the U-shaped portion is moved toward the two grooves to form the storage state, so that two symmetrical sections on two opposite sides of the U-shaped portion enter the two grooves for positioning.

8. The Hi-hat brass cymbal stand according to claim 1, wherein the Hi-hat brass cymbal stand further has a foot stand including a fixed ring connected to the storage tube, a movable ring movably sleeved on the storage tube, and a plurality of foot plates pivotally connected between the fixed ring and the movable ring, when the movable ring is moved close to the fixed ring, the foot plates are swung to form a use state, and when the movable ring is moved far away from the fixed ring, the foot plates are swung relative to the fixed ring to be changed from the use state to the storage state.

9. The Hi-hat brass cymbal stand according to claim 1, wherein the first pulling mechanism comprises a buffer located between the first connector and the fixer, and the buffer has a buffer spring and at least one buffer pad, when a user steps on the pedal mechanism, the first pulling mechanism is pulled downward to separate the buffer from the fixer, and when the foot of the user leaves the pedal mechanism, the first pulling mechanism is pushed by the buffer spring to return to an unpulled position.

10. The Hi-hat brass cymbal stand according to claim 1, wherein the first pulling mechanism has a return spring and a stretching member for being moved, the return spring is connected to the stretching member, and the first joint tube has a spring adjustment ring connected to the stretching member, so that a user is capable of adjusting the tightness of the pedal through the spring adjustment ring when stepping on the pedal.
